(19) United States
(12) Patent Application Publication
(10) Pub. No.: US 2008/0140740 A1
(43) Pub. Date: Jun. 12, 2008

(54) SYSTEMS AND METHODS FOR PROCESSING DATA SETS IN PARALLEL

(75) Inventors: Clifton J. Williamson, Saratoga, CA (US); Jonathan J. Ashley, Los Gatos, CA (US)

Correspondence Address: HAMILTON AND DESANCTIS, 8555 W. BELLEVIEW AVE., LITTLETON, CO, 80123, US

(73) Assignee: Agere Systems Inc.

(21) Appl. No.: 11/608,709

(22) Filed: Dec. 8, 2006

(51) Int. Cl. G06F 7/38

(52) U.S. Cl. 708/200

(57) ABSTRACT

Various parallel processing devices, methods for designing such and using such are disclosed herein. For example, a parallel linear processing device is disclosed that includes two multipliers. One of the multipliers is operable to multiply a feedback signal by a first value and to provide a first multiplier output. The other multiplier is operable to multiply a data input by a second value and to provide a second multiplier output. The processing device further includes an adder and a register. The adder is operable to sum at least the first multiplier output and the second multiplier output and to provide an adder output. The register is operable to register the adder output as a register output, and the feedback signal provided to the first multiplier is derived from the register output.

### BACKGROUND OF THE INVENTION

The present invention is related to parallel processing systems. More particularly, the present invention is related to processing data sets in a general linear system.

Various products process encoded data to recover an original data set. For example, magnetic storage devices receive information that is to be stored and later retrieved. The process of storing the data includes encoding an original data set and storing the encoded data set on a magnetic medium at a location indicated by an address. Later, the encoded data is accessed from the magnetic medium, decoded, and presented to a requester. The processes of encoding and decoding the data typically utilize error correcting codes as part of a data integrity scheme in which blocks of user data are encoded with error correction code parity before being written to the magnetic medium. Adding parity enables certain mathematical algorithms that locate and correct errors occurring while data are accessed from the magnetic medium. Data retrieved from the medium may be corrupted by events such as electronic noise, defects on the medium, or improper positioning of the head. Such events may result in read errors, which are typically handled by the error correction code. Additionally, an address error may occur when a block of data is read from the wrong location on the medium. Thus, assuring data integrity requires guarding against both read errors and address errors.

Typically, blocks of data called sectors are given logical or physical block addresses that specify a particular track on the magnetic medium as well as a particular location within that track. Tracks on the magnetic medium are typically identified by information written in the servo field that indicates the track over which the head is currently positioned. One way of identifying the individual sectors on a track is by writing a header containing address information immediately before each sector. However, writing this information takes up space on the magnetic medium, thereby reducing the effective capacity of the magnetic storage device.

Use of headers may be avoided through use of a lookup table that provides track formats that can be read from memory when the head passes over a servo. The format for any given track contains information from which the addresses of the sectors on that track can be computed. This avoids the need to write a header for each sector, but increases the probability of an address error. Sometimes a pseudo-randomizer seeded with address information is used as a safeguard against address errors. The seed completely determines a sequence of bits that is output by the randomizer and XORed into the data and parity bits of the encoded sector before that sector is written to the magnetic medium. When the sector is read from the medium, the same seed is used and the same sequence of bits is XORed in to the sector bits, thereby restoring the original block of data. If a sector is accidentally read from an incorrect address, the seed used during decoding will be different than the seed that was used during encoding. Hence, a different sequence of bits will be output by the randomizer, resulting in a substantial number of errors and an uncorrectable sector. Normally uncorrectable data will trigger a retry (i.e., a second attempt to read the same sector) that may be more successful at reading from the proper address. While this approach may rectify an attempt to read from an incorrect address, there is no way to distinguish between an address error and a sector that was uncorrectable for some other reason.

Another approach to eliminating the need to write header information is to treat address information as additional user data, but without actually writing the address information to the magnetic medium. Instead, the address that would normally be written as a header to the magnetic medium is used in both the error correction code encoding and decoding processes so that the address information is protected by the error correction process generally applied to the user data. Using such an approach, blocks of data may be partitioned into symbols consisting of M bits, where M is a fixed integer. For example, when M equals eight, each symbol is referred to as a byte. User data symbols are transferred to an encoder which computes a number of parity symbols. In turn, the parity symbols are appended to the user data to form a block of encoded data called a codeword.

When a codeword is read from the magnetic medium, errors may be introduced and the first step in the decoding is to transfer the (possibly corrupted) codeword to a syndrome computation block. The syndrome values indicate if any errors have occurred and, if necessary, serve as the inputs to the first stage in the error correction process. Later stages find the locations of the symbols in error, whether they be data or parity symbols, and determine the respective error values. The aforementioned process may be extended to detect and correct errors in address information where the address information header is included in the codeword with the user data so that the encoder computes parity using both the header and user data.

In such a case, the header may be provided to the encoder from a source other than that of the user data in much the same way that the pseudo-randomizer was seeded with address information in the discussion above. However, for the purposes of error correction, the header data symbols are treated merely as additional user data symbols, so parity symbols are computed as usual during the encoding phase and corrections are computed as usual during the decoding phase. The address information need not be written to the magnetic medium since that information will be known when the sector is retrieved. An address error occurs when a different header is used in the decoding phase than was used in the encoding phase. In that case, the correction logic will detect errors in the header data symbols, thereby identifying an address error. In addition, the corrections can be used to determine the address that was used during encoding.

Implementing the aforementioned approach does not require substantial changes to either the encoder or the syndrome computer. In both cases, the header information can be transferred to the appropriate block prior to the actual user data. However, in hardware this approach requires additional clock cycles to process the header data symbols, which impacts the latency of the system and limits the amount of data that the header can contain.

Hence, for at least the aforementioned reasons, there exists a need in the art for advanced systems and methods for processing information sets.

### BRIEF SUMMARY OF THE INVENTION

The present invention is related to parallel processing systems. More particularly, the present invention is related to processing data sets in a general linear system.

Various parallel processing devices, methods for designing such and using such are disclosed herein. For example, some embodiments of the present invention provide parallel linear processing devices that include two multipliers. One of the multipliers is operable to multiply a feedback signal by a first value and to provide a first multiplier output. The other multiplier is operable to multiply a data input by a second value and to provide a second multiplier output. The processing device further includes an adder and a register. The adder is operable to sum at least the first multiplier output and the second multiplier output and to provide an adder output. The register is operable to register the adder output as a register output, and the feedback signal provided to the first multiplier is derived from the register output.

In some instances of the aforementioned embodiments, the adder is a first adder and the data input is a first data input. In such embodiments, the processing device may be a parallel encoding device that further includes a multiplexer and a second adder. The multiplexer is operable to select between a second data input and the register output to drive an encoder output, and the second adder is operable to sum the register output with the encoder output and to provide the feedback signal. In some cases, the first value is a coefficient of a term of a polynomial of a first degree, and the second value is a coefficient of a term of the polynomial of a second degree. In such cases, the first degree is a greater degree than the second degree. As used herein, the term “degree” is used in its broadest sense to mean the degree of a polynomial. Thus, for example, in the polynomial ax³+bx²+cx+d, the coefficient a is the coefficient of the term of degree three, the coefficient b is the coefficient of the term of degree two, the coefficient c is the coefficient of the term of degree one, and the coefficient d is the coefficient of the term of degree zero of the polynomial.

In other such cases, the second data input is a series of base data and the first data input is a series of data describing the base data. Thus, for example, the second data input may be a set of user data to be written to a hard disk drive, and the first data input may be header data associated with the user data. In the aforementioned cases, the encoder output includes an encoded version of an aggregate of the base data and error correction data that is based both on the base data and the data describing the base data. As one example, the error correction data may be parity data. Based on the disclosure provided herein, one of ordinary skill in the art will recognize a variety of base data and associated descriptive data that may be used in relation to one or more embodiments of the present invention. Further, based on the disclosure provided herein, one of ordinary skill in the art will recognize that two mutually exclusive data sets may be introduced with one of the data sets being applied to the first input and the other data set being applied to the second input. As another example, the same user data set may be divided with each segment of the user data set being input into a respective one of the first input and the second input where the circuit is limited to two inputs, or into respective ones of multiple inputs where the circuit consists of more than two inputs.

In other instances of the aforementioned embodiments, the data input may be a first data input and the processing device may be a parallel syndrome computing device. In such instances, the parallel syndrome computing device further includes a second data input that is summed with the first multiplier output and the second multiplier output by the adder. In such cases, the first value is a coefficient of a term of a polynomial of a first degree, and the second value is a coefficient of a term of the polynomial of a second degree. In such cases, the first degree is a greater degree than the second degree.

Other embodiments of the present invention provide generalized parallel linear processing devices. Such processing devices include one or more registers and are discussed herein as a first register and a second register. Each of the registers is synchronized to a clock. The devices further include a combinatorial logic block that receives a first input, and outputs from one or more of the registers. The next state of the registers is calculated as a linear function of the current state and the first input. The devices further include an input modifier associated with each of the registers, and the input modifiers are respectively operable to modify a second input to create respective modified outputs. The respective modified outputs are provided to respective adders that sum the modified output with state information from the combinatorial logic. The output of each of the respective adder outputs is registered by the respective registers upon assertion of the clock.

In some instances of the aforementioned embodiments, the processing devices are linear systems exhibiting a state update formula in accordance with the following equation: Sᵢ₊₁=M·Sᵢ+L·Uᵢ, where S₀ is the initial state and equals zero, M is a linear map from a state space to itself, and L is a linear map from the input to the state space. The linear maps M and L, as well as the addition function, are implemented as combinatorial logic. The circuit allows for a parallel input, U, with k input values (i.e., U₀, U₁, U₂ . . . Uₖ₋₁). To do so, a parallel input function is defined as Pᵢ=Uᵢ for 0≦i≦k−1, and Pᵢ=0 for k≦i; and Rᵢ=Uᵢ₊ₖ for 0≦i. Thus, P operates as another data set to be processed in parallel, and R is the remainder. The state update formula for the parallelized system is then yielded by the calculation: Tᵢ₊₁=M·Tᵢ+LᵢRᵢ+M^{k}·L·Pᵢ, where T₀ equals zero. This parallelized system emulates a non-parallel system where all of the data is fed serially to the system in the sense that Tᵢ=Sᵢ₊ₖ, for i≧k.

Other embodiments of the present invention provide methods for processing in a syndrome computer. Such methods include providing a processing device. The processing device includes at least two multipliers. A first one of the multipliers is operable to multiply a register output by a first value and to provide a first multiplier output, and a second one of the multipliers is operable to multiply a first data input by a second value and to provide a second multiplier output. The processing device further includes an adder that is operable to sum the first multiplier output, the second multiplier output and a second data input. The adder output is registered by a register that in turn provides a register output. The method includes initializing the register to a known state, applying a first data element to the first data input, and applying a second data element to the second data input. The register is then clocked and upon clocking, the register contains a polynomial value.

Yet other embodiments of the present invention provide methods for encoding two data sets in parallel. The methods include providing an encoder circuit that includes a multiplexer, four multipliers, three adders and two registers. The multiplexer is operable to select between a first data input and a second register output to drive an encoder output, and the first adder is operable to sum the second register output with the encoder output and to provide a first adder output. The first multiplier is operable to multiply the first adder output by a first value and to provide a first multiplier output, and the second multiplier is operable to multiply a second data input by a second value and to provide a second multiplier output. The second adder is operable to sum the first multiplier output with the second multiplier output and to provide a second adder output, and the first register is operable to register the second adder output as the a first register output. The third multiplier is operable to multiply the first adder output by a third value and to provide a third multiplier output, and the fourth multiplier is operable to multiply the second data input by a fourth value and to provide a fourth multiplier output. The third adder is operable to sum the third multiplier output, the fourth multiplier output and the first register output together, and to provide a third adder output. The second register is operable to register the third adder output as the a second register output. The aforementioned methods include initializing the first register and the second register to a known state; applying a first data element to the first data input, and applying a second data element to the second data input; and clocking the second register, such that the second register contains a first coefficient of a first degree of a polynomial and a second coefficient of a second degree of the polynomial, wherein the first data element is a first coefficient of a first degree of another polynomial and the second data element is a second coefficient of a second degree of the other polynomial.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a prior art encoder;

FIG. 2 depicts a prior art user data packet appended with parity data using a circuit such as that shown in FIG. 1;

FIG. 3 shows a parallel polynomial encoder in accordance with one or more embodiments of the present invention;

FIG. 4 shows a prior art syndrome computer;

FIG. 5 depicts a parallel syndrome computer in accordance with various embodiments of the present invention;

FIG. 6 is a timing diagram showing a zero delay switching used to describe the subsequent circuits;

FIG. 7 shows a linear circuit;

FIG. 8 depicts a parallel linear circuit in accordance with various embodiments of the present invention;

FIG. 9 is a prior art syndrome computer showing an output transfer function and constituent elements thereof;

FIG. 10 is a prior art encoder showing an output transfer function and constituent elements thereof;

FIG. 11 depicts a two-block systematic encoder in accordance with some embodiments of the present invention; and

FIG. 12 depicts a multi-block systematic encoder in accordance with one or more embodiments of the present invention.

### DETAILED DESCRIPTION OF THE INVENTION

The present invention is related to parallel processing systems. More particularly, the present invention is related to processing data sets in a general linear system.

The present invention provides coding systems that in some cases incorporate address information into a Reed-Solomon error correcting code. Such coding systems may be, but are not limited to, encoding sectors for storage on a magnetic storage medium. One or more of the decoding systems in accordance with various embodiments of the present invention provide for detecting and characterizing both address and user data errors without increasing the format overhead or adding latency to an encoding/decoding process that would traditionally only detect and characterize errors in the user data.

Various embodiments of the present invention perform the aforementioned functions using linear circuits capable of processing two or more blocks of data in parallel. For example, one embodiment of the present invention provides for processing a user data block and an associated address block in parallel. In one particular case, a systematic encoder for a Reed-Solomon code is modified to accept parallel address and user data streams. As another particular case, a syndrome computer for a Reed-Solomon code is modified to accept parallel address and user data streams. In both cases, the circuits are modified to accept address data in parallel with the traditional block of user data. In such cases, the address block identifies a location for the encoded user data on a magnetic storage medium. By including address information in the encoding process, the Reed-Solomon error control system is able to identify address errors during the operation of the device. It should be noted that while the aforementioned particular examples are described in detail herein, various other linear circuits may be modified for parallel operation using approaches disclosed herein. Further, it should be noted that while the aforementioned particular examples allow for two parallel data paths that other linear circuits may be modified to process three or more parallel paths using a logical extension of the approach for implementing two data paths. Based on the disclosure provided herein, one of ordinary skill in the art will appreciate that the methods for modifying linear circuits as discussed herein may be used.

The operation of the aforementioned circuits can be described in mathematical terms using polynomials whose coefficients have a fixed number (M) of bits. Often it is useful to refer to power series with M-bit coefficients, which are essentially polynomials with an infinite number of terms. To fully understand the computational circuitry, the mathematical operations of addition, subtraction, multiplication, and division are defined for the aforementioned M-bit coefficients using a known Galois field approach. As known in the art, a Galois field GF(2^{M}) provides a way of defining arithmetic operations on arrays of M bits that can be efficiently implemented in hardware. For example, both addition and subtraction can be implemented using the same bitwise XOR function without carries and complements. Multiplication is somewhat more complicated but can be implemented in combinatorial logic with a delay under one clock cycle. Division works via the computation of reciprocals using, for example, a lookup table. Again, Galois field arithmetic is generally known in the art and is more fully discussed in the following references: (A) E. Berlekamp, “Algebraic Coding Theory, Revised 1984 Edition”, Aegean Park Press, Walnut Creek, Calif. 1984; (B) R. Blahut, “Algebraic Codes for Data Transmission”, Cambridge University Press, New York and Cambridge, 2003; (C) G. C. Clark et al. “Error-Correction Coding for Digital Communications”, Plenum Press, New York and London, 1981; (D) S. Lin et al., “Error Control Coding: Fundamentals and Applications”, Prentice-Hall, Inc., Englewood Cliffs, N.J., 1983; and (E) W. W. Peterson et al., “Error-Correcting Codes, Second Edition”, The MIT Press, Cambridge, Mass., 1972. Each of the aforementioned five references is incorporated herein by reference for all purposes. Throughout this application M bit symbols are discussed as elements of the Galois field GF(2^{M}).

As a general background, a polynomial code is defined in terms of a generator polynomial containing a number of terms consisting of coefficients multiplied by progressively higher powers of a variable. An example of such a generator polynomial is represented as: g(x)=x^{r}+gᵣ₋₁x^{r-1}+ . . . +gₗx+g₀, with coefficients gⱼ ε GF(2^{M}) multiplied by powers x^{j} of the variable x. The polynomial code generated by g(x) consists of all polynomials c(x) with coefficients in GF(2^{M}) such that c(x) is divisible by g(x) (i.e., such that there is a polynomial f(x) with c(x)=g(x)·f(x)). A polynomial is identified with the data block consisting of its coefficients and there is usually a restriction on the number of symbols in the block, that is, on the degree of the polynomial. For a positive integer n, the code C generated by g(x) of block size n is:

C={c(x)εGF(2^{M})[x]: deg(c)<n, g(x)|c(x)}.

An encoding algorithm takes a block of k=n−r data symbols and returns a codeword consisting of n symbols. In polynomial notation, the encoding algorithm takes a data polynomial d(x) of degree k−1 and returns a codeword polynomial c(x) of degree n−1. In general, the simplest way to create the aforementioned codeword is to generate a codeword of the following product: c(x)=d(x)·g(x), where the data symbols are represented as d(x). The drawback with this approach is that the data symbols (i.e. the coefficients of d(x)) do not appear among the codeword symbols (i.e., the coefficients of c(x)).

Systematic encoding may be utilized such that when a data polynomial (i.e. d(x)) is encoded, so that the coefficients of d(x) appear among the coefficients of c(x). In this way, the original data symbols remain intact and parity symbols are appended to user data symbols to produce a codeword. Systematic encoding is typically accomplished through polynomial division. Dividing x^{r}·d(x) by the degree r polynomial g(x), one computes a quotient q(x) and a remainder p(x) which satisfy

x^{r}·d(x)=q(x)·g(x)+p(x),

where the polynomial p(x) has a lower degree than the polynomial g(x) (i.e. deg(p)<deg(g)=r). Thus, c(x)=x^{r}·d(x)+p(x)=q(x)·g(x), so c(x) is a multiple of g(x) and is, hence, a valid codeword. Since addition and subtraction are the same operation in GF(2^{M}), there is no sign error in the last equation. Note that since deg(p)<r−1, the sum x^{r}·d(x)+p(x) is essentially a concatenation of the coefficients of d(x) with the coefficients of p(x). Therefore, the data symbols in d(x) are the coefficients of the terms in c(x) of degree r and higher and the parity symbols in p(x) are the coefficients of the terms of degree less than r. The remainder p(x) is referred to as the reduction of x^{r}·d(x) modulo g(x), and can be written as:

p(x)=x^{r}·d(x) (mod g(x)).

In hardware a block of user data is typically transferred to an encoder one symbol per clock cycle. Such hardware utilizes registers to store r elements of GF(2^{M}), and at each stage in the computation the hardware computes a polynomial reduced (mod g(x)) and stores the coefficients of the polynomial in the registers. New values are captured by the registers on each active clock edge, and upon processing all of the data symbols the registers contain the coefficients of p(x).

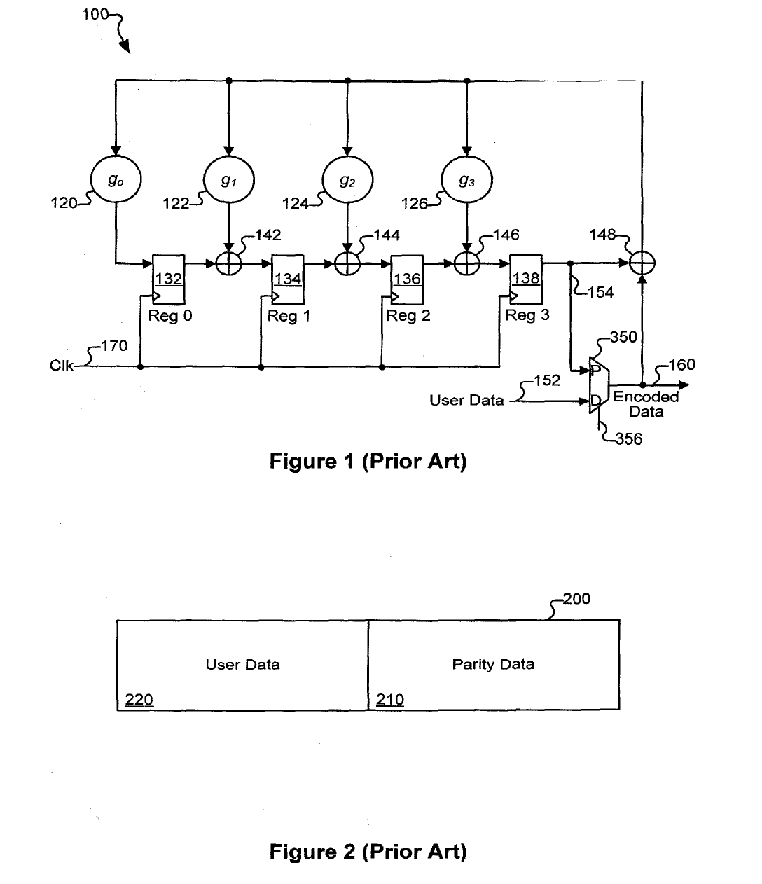

Turning to FIG. 1, an exemplary architecture for an encoder 100 for a code with generator polynomial g(x)=x⁴+g₃x³+g₂x²+g₁x+g₀ of degree r=4 using the principles discussed above. Encoder 100 includes a number of constant multipliers coefficients 120, 122, 124, 126 that correspond to the coefficients of polynomial g(x) (i.e., logic that multiples an arbitrary element of GF(2^{M}) by a constant value of the particular coefficient); a number of adder circuits 142, 144, 146, 148; a number of registers 132, 134, 136, 138 that are synchronized to a common clock 170; a multiplexer 350 capable of selecting between encoder data 154 and user data 152 using a selection input 356. All buses depicted in encoder 100 are M bits wide. Each of adder circuits 142, 144, 146, 148 may be implemented as banks of M XOR gates, and each of registers 132, 134, 136, 138 may be implemented as banks of M flip-flops. Thus, when a polynomial of degree r−1=3 is stored in the registers, the coefficient of degree i will be stored in Reg i for i=0, 1, 2, and 3.

A block of k M-bit data symbols is transferred to encoder 100 via user data input 152, with one data symbol being transferred each clock cycle. In operation, selection input 356 is asserted such that user data 152 is provided to an encoded data output 160, and on each of k cycles of clock input 170 M sequential bits of user data 152 are transferred to encoder 100. Thus, for example, suppose that registers 132, 134, 136, 138 contain the coefficients of the polynomial a(x)=a₀+a₁x+a₂x²+a₃x³ (i.e. a₀ is the value in register 132, a₁ is the value in register 134, a₂ is the value in register 136, and a₃ is the value in register 136) and that user data input 152 is d. After the next cycle of clock input 170, registers 132, 134, 136, 138 will contain x·a(x)+d·x⁴ (mod g(x)). Because x·a(x)+d·x⁴ equals a₀x+a₁x²+a₂x³+(a₃+d)x⁴, the reduction (mod g(x) ) is achieved through a simple subtraction of (a₃+d)·g(x). As previously discussed, the addition and subtraction operations are the same, and therefore the following operation provides the aforementioned (mod g(x)) reduction:

(a₃+d)·g₀+((a₃+d)·g₁+a₀)x+((a₃+d)·g₂+a₁)x²+((a₃+d)·g₃+a₂)x³

### Considering encoder 100, the coefficients of the aforementioned polynomial become the contents of registers 132, 134, 136, 138 after the next active edge of clock input 170.

The following provides a more generalized description of the operation of encoder 100 to encode a data polynomial d(x)=d₀x^{k-1}+d₁x^{k-2}+ . . . +dₖ₋₂x+dₖ₋₁. The coefficients dᵢ are transferred to encoder 100 as a serial grouping of user data starting with d₀ and ending with dₖ₋₁, with one element of the user data being received for each cycle of clock input 170. In operation, registers 132, 134, 136, 138 are first cleared, so that the registers contain the coefficients of the polynomial a(x)=0. Initially, user data 152 presented to the encoder is d₀, and after the first clock cycle the registers of the encoder contain the coefficients of x·a(x)+d₀x⁴=0+d₀·x⁴=d₀·x⁴ (mod g(x)). User data 152 is then changed to d₁ and the registers contain the coefficients of the polynomial a(x)=d₀·x⁴ (mod g(x)). After the second clock cycle registers 132, 134, 136, 138 contain the coefficients x·a(x)+d₁·x⁴=d₀·x⁵+d₁·x⁴ (mod g(x)). The process continues by sequentially presenting subsequent elements of the user data that are each clocked into the registers of the encoder such that registers 132, 134, 136, 138 contain the coefficients of

d₀·x^{k+3}+d₁·x^{k+2}+ . . . +dₖ₋₂·x⁵+dₖ₋₁·x⁴ (mod g(x)),

which is the desired x⁴·d(x) (mod g(x)).

As the user data (i.e. dᵢ) are transferred to encoder 100, they are also transferred out of encoder 100 as encoded data 160. This is to be expected as the data symbols appear in the encoded block of data. After the last data symbol has been transferred to encoder 100, registers 132, 134, 136, 138 contain the coefficients of the parity polynomial p(x). At this point, encoder data 154 is selected as the output of multiplexer 350 by using selection input 356. Therefore, the inputs to the adder 148 are identical, so the output of the adder 140 is 0, as are the outputs of the multipliers 120, 122, 124, 126. As a result, the values in the registers are shifted out of encoder 100 over the next four clock cycles, starting with the coefficient of p(x) of degree three and ending with the coefficient of degree zero. In this way, parity symbols 210 are appended to user data 220 to form a complete codeword 200 as shown in FIG. 2.

It should be noted that encoder 100 may be used to encode header data along with user data. For example, where there are three header symbols (e₀, e₁, e₂), these symbols can be transferred to encoder 100 over three clock cycles directly preceding the clocking of the user data into encoder 100. This results in encoding the following data polynomial:

x^{k}·e(x)+d(x)=(e₀x^{k+2}+e₁x^{k+1}e₂x^{k})+(d₀x^{k-1}+d₁x^{k+2}+ . . . +dₖ₋₂x+dₖ₋₁),

where e(x) is the header polynomial e₀x²+e₁x+e₂. The encoding process including the header information requires three additional clock cycles and the insertion of header data preceding the user data. In some cases this provides an adequate solution, however, in other cases such an approach is not acceptable.

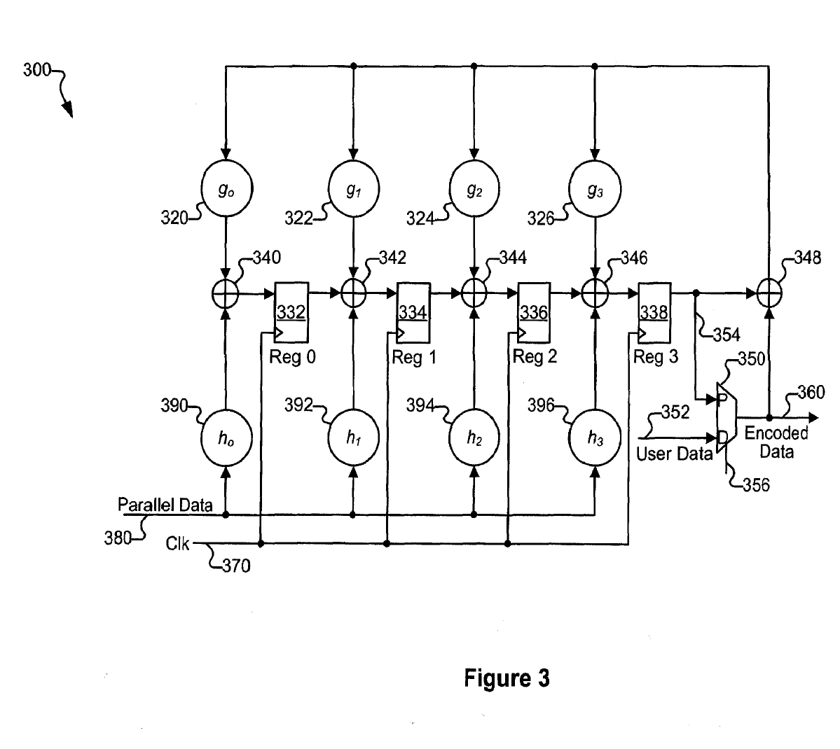

Turning to FIG. 3, an encoder 300 capable of parallel processing a data set in addition to the user data discussed above in relation to encoder 100 is depicted. The additional data set may be, for example, the aforementioned header data (e₀, e₁, e₂). By parallel processing the header data, various disadvantages of encoder 100 may be overcome. Encoder 300 includes a number of constant multipliers 320, 322, 324, 326 that correspond to the coefficients of the generator polynomial g(x) (i.e., logic that multiples an arbitrary element of GF(2^{M}) by a constant value of the particular coefficient); another number of constant multipliers 390, 392, 394, 396 that correspond to the coefficients of a polynomial h(x) (i.e., logic that multiples an arbitrary element of GF(2^{M}) by a constant value of the particular coefficient); a number of adder circuits 340, 342, 344, 346, 348; a number of registers 332, 334, 336, 338 that are synchronized to a common clock 370; a multiplexer 350 capable of selecting between encoder data 354 and user data 352 using a selection input 356. All buses depicted in encoder 300 are M bits wide. Each of adder circuits 340, 342, 344, 346, 348 may be implemented as banks of M XOR gates, and each of registers 332, 334, 336, 338 may be implemented as banks of M flip-flops. Thus, when a polynomial of degree r−1=3 is stored in the registers, the coefficient of degree i will be stored in Reg i for i=0, 1, 2, and 3.

Considering encoder 300, parallel data 380 is processed in parallel with user data 352. In this case, assume that there are three header symbols to be processed in parallel, and the polynomial h(x)=h₃x³+h₂x²+h₁x+h₀ is the reduction of x⁷ (mod g(x) ). If a value e is transferred into decoder as parallel data 380, the outputs of multipliers 390, 392, 394, 396 are the coefficients of ex⁷ (mod g(x)). Thus, supposing that registers 332, 334, 336, 338 contain the coefficients of the polynomial a(x)=a₀+a₁x+a₂x²+a₃x³,that the user data input is d, and that the parallel data input is e; upon clocking registers 332, 334, 336, 338 they will contain the polynomial x·a(x)+e·x⁷+d·x⁴ (mod g(x)). This polynomial is further processed as additional data are clocked in from parallel data 380 and from user data 352.

In operation, registers 332, 334, 336, 338 are first cleared followed by applying d₀ to the user data input 352 and e₀ to the parallel data input 380. Then, e₀ is multiplied by multipliers 390, 392, 394, 396 and d₀ is multiplied by multipliers 320, 322, 324, 326. The respective products of the multiplications are clocked into registers 332, 334, 336, 338 so that the coefficients of the polynomial e₀·x⁷+d₀·x⁴ (mod g(x)) are stored in the registers. During the subsequent clock cycle, the next data symbol d₁ is applied to the user data input 352 and header symbol e₁ is applied to the parallel data input 380, so that the coefficients of the polynomial e₀·x⁸+e₁·x⁷+d₀·x⁵+d₁19 x⁴ (mod g(x)) are clocked into registers 332, 334, 336, 338. Then data symbol d₂ is applied to the user data input 352 and header symbol e₂ is applied to the parallel data input 380, so that the coefficients of the polynomial e₀·x⁹+e₁·x⁸+e₂·x⁷+d₀·x⁶+d₁·x⁵+d₂·x⁴ (mod g(x)) are clocked into registers 332, 334 336, 338. This process continues and during the i^{th} iteration (for i>3) dᵢ₋₁ is applied to the user data input 352 and zero is applied to the parallel data input 380. At this time, the coefficients of e₀·xⁱ⁺⁶+e₁·xⁱ⁺⁵+e₂·xⁱ⁺⁴+d₀·xⁱ⁺³+d₁·xⁱ⁺²+ . . . +dᵢ₋₂·x⁵+dᵢ₋₁·x⁴ (mod g(x)) are clocked into registers 332, 334, 336, 338. Then, after the k^{th} iteration, registers 332, 334, 336, 338 contain the coefficients of

e₀·x^{k+6}e₁·x^{k+5}e₂·x^{k+4}+d₀·x^{k+3}d₁·x^{k+2}+ . . . +dₖ₋₂·x⁵+dₖ₋₁·x⁴ (mod g(x)).
Once all of the data symbols have been applied to user data 352 and clocked into registers 332, 334, 336, 338, encoder data 354 is selected via selection input 356 and the parity symbols are clocked out of registers 332 334, 336, 338 to encoded data 360. As before, user data symbols dᵢ are output as encoded data as they are passed to the encoder. The parallel data symbols are not output by the encoder.

The values h₀, h₁, h₂, and h₃ can be computed using encoder 100. If data polynomial d(x)=x³ is encoded, the circuit is designed to compute the reduction of x⁷ (mod g(x)). Since x³=1·x³+0·x²+0·x+0, there are four data symbols, and thus, four encoding iterations. During the first iteration, the user data input is one and during the next 3 iterations the input is zero. After the fourth iteration, the register Reg i will contain the value hᵢ for i=0, 1, 2, and 3.

Based on the preceding discussion, it will be appreciated that the circuits discussed in relation to FIG. 1 and FIG. 3 may be modified to handle the case of a generator polynomial g(x) of arbitrary degree r and a header containing an arbitrary number s of data symbols, as long as s is no greater than the number of data symbols k. To do so, encoder 100 will have r banks of flip-flops and there will be r constant multipliers, one for each coefficient of g(x). The additional r constant multipliers used for encoder 300 will correspond to the coefficients of the reduction of x^{r+s} (mod g(x)). Again these values can be obtained by operating encoder 100 for s+1 clock cycles, where the input on the first clock cycle is one and the input on the subsequent s clock cycles is zero.

Various embodiments of the present invention apply the preceding principles to a syndrome computer where data is similarly partitioned into M-bit symbols that are viewed as elements of GF(2^{M}). A Reed-Solomon code has a generator polynomial, g(x), that splits into linear factors over GF(2^{M}) so that all the roots of g(x) are elements of GF(2^{M}). More specifically, the roots of g(x) are the consecutive powers of a primitive element of GF(2^{M}). Additional discussion is available in any of: (A) E. Berlekamp, “Algebraic Coding Theory, Revised 1984 Edition”, Aegean Park Press, Walnut Creek, Calif. 1984; (B) R. Blahut, “Algebraic Codes for Data Transmission”, Cambridge University Press, New York and Cambridge, 2003; (C) G. C. Clark et al., “Error-Correction Coding for Digital Communications”, Plenum Press, New York and London, 1981; (D) S. Lin et al., “Error Control Coding: Fundamentals and Applications”, Prentice-Hall, Inc., Englewood Cliffs, N.J., 1983; and (E) W. W. Peterson et al., “Error-Correcting Codes, Second Edition”, The MIT Press, Cambridge, Mass., 1972. Each of the aforementioned five references was previously incorporated herein by reference for all purposes.

In general, if g(x)=(x−a₀)·(x−a₁) . . . (x−aᵣ₋₁), then a polynomial c(x) is divisible by g(x) precisely when c(a₁)=0 for i=0, 1, . . . , r−1. Thus, computing these polynomial values provides a test as to whether or not c(x) is a codeword. When c(x) is stored on a magnetic medium, the block \tilde{c}(x) read from the medium may have errors introduced into it. A coefficient \tilde{c}ⱼ of \tilde{c}(x) is corrupted precisely when \tilde{c}ⱼ≠cⱼ. To determine whether errors have occurred, one typically computes the r polynomial values \tilde{c}(aᵢ), which are referred to as syndromes. If any one of the syndromes is non-zero, we know that read errors have been introduced. The r syndromes are often the inputs to the first stage of the error correction procedure.

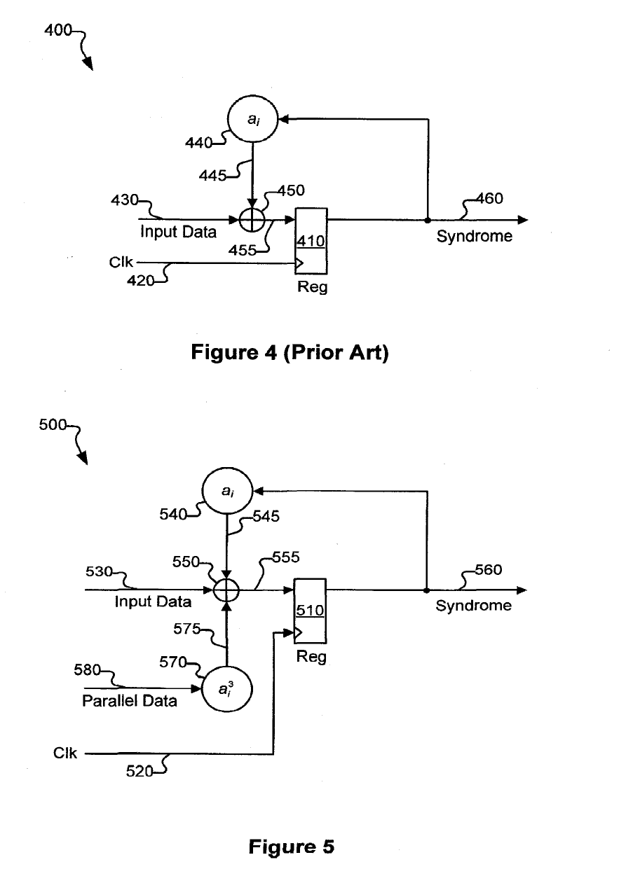

Hardware for such syndrome computation is shown as a syndrome computer 400 of FIG. 4. Syndrome computer 400 includes a number of buses 430, 445, 455, 460 that are each M bits wide and a register 410 that consists of M flip-flops that are synchronized by a clock input 420. A constant multiplier 440 multiplies a register output 460 by the constant multiplicand aᵢ, and the product is added to a user input 430 via an adder circuit 450. As background, let c(x)=c₀x^{k+r-1}+c₁x^{k+r-2}+ . . . cₖ₊ᵣ₋₂x+cₖ₊ᵣ₋₁ be a codeword with k data symbols and r parity symbols. In a typical scenario, the data symbols will be the first k symbols c₀, c₁, . . . , cₖ₋₁, and the parity symbols will be the final r symbols cₖ, cₖ₊₁, . . . , cₖ₊ᵣ₋₁. The potentially corrupted codeword \tilde{c}(x)=\tilde{c}₀x^{k+r-1}+c₁x^{k+r-2}+ . . . +\tilde{c}ₖ₊ᵣ₋₂x+\tilde{c}ₖ₊ᵣ₋₁ is read from a magnetic medium and passed to r syndrome computers 400 one symbol per clock cycle.

In operation, register 410 is cleared and prior to the first active edge of clock input 420, \tilde{c}₀ is applied to input data 430. After the first active edge of clock input 420, register 410 contains the value \tilde{c}₀. \tilde{c}₁ is then applied to input data 430 and after the next active edge of clock input 420, register 410 contains the value \tilde{c}₀a₁+\tilde{c}₁. During the third iteration, \tilde{c}₂ is applied to input data 430, and after the next active edge of clock input 420, register 410 contains the value \tilde{c}₀a₁²+\tilde{c}₁a₁+\tilde{c}₂. During the (k+r)^{th} iteration, \tilde{c}ₖ₊ᵣ₋₁ is applied to input data 430 and after the next active edge of clock 420, register 410 contains the value 0\tilde{c}(a₁)=\tilde{c}₀a₁^{k+r-1}+\tilde{c}₁a₁^{k+r-2}+ . . . +\tilde{c}ₖ₊ᵣ₋₂aᵢ+\tilde{c}ₖ₊ᵣ₋₁. The value \tilde{c}(aᵢ) is then syndrome output 460. Now, supposing that codeword c(x) contains three header symbols e₀, e₁, e₂, the original polynomial is c(x)=e₀x^{k+r+2}+e₁x^{k+r+1}+e₂x^{k+r+}c₀x^{k+r-1}+c₁x^{k+r-2}+ . . . +cₖ₊ᵣ₋₂x+cₖ₊ᵣ₋₁. The corrupted version including the header data is thus, \tilde{c}(x)=\tilde{e}₀x^{k+r+2}+\tilde{e}₁x^{k+r+1}+\tilde{e}₂x^{k+r}+\tilde{c}₀x^{k+r-1}+\tilde{c}₁x^{k+r-2}+ . . . +\tilde{c}ₖ₊ᵣ₋₂x+\tilde{c}ₖ₊ᵣ₋₁. The coefficients \tilde{c}ᵢ are corrupted when read errors occur, and the coefficients \tilde{e}ᵢ are corrupted when an address error occurs. In such a case, the syndrome \tilde{c}(aᵢ) can again be computed using syndrome computer 400, but three additional clock cycles are required to process the header data symbols which are applied serially to input data 430.

Turning to FIG. 5, a syndrome computer 500 capable of accepting a parallel data input is depicted. Syndrome computer 500 includes a number of buses 530, 545, 555, 560, 575, 580 that are each M bits wide and a register 510 that consists of M flip-flops that are synchronized by a clock input 520. A constant multiplier 540 multiplies a register output 560 by the constant multiplicand aᵢ. Another constant multiplier 570 multiplies a parallel input 580 by the constant multiplicand aᵢ³. The products of both constant multiplier 540 and constant multiplier 570 are added to a user input 530 via an adder circuit 550. In this case, the aforementioned header symbols e₀, e₁, e₂ are applied to parallel data input 580, and the user data are applied to input data 530.

In operation, register 510 is cleared and prior to the first active edge of clock input 520, \tilde{c}₀ is applied to input data 530 and \tilde{e}₀ is applied to parallel data 580. Upon the first active edge of clock input 520, register 510 contains the value \tilde{e}₀aᵢ³+\tilde{c}₀. \tilde{c}₁ is then applied to input data 530 and \tilde{e}₁ is applied to parallel data 580, and after the next active edge of clock input 520, register 510 contains the value \tilde{e}₀aᵢ⁴+\tilde{e}₁aᵢ³+\tilde{c}₀aᵢ+\tilde{c}₁. During the third iteration, \tilde{c}₂ is applied to input data 530 and \tilde{e}₂ is applied to parallel data 580, and after the next active edge of clock input 520, register 510 contains the value \tilde{e}₀aᵢ⁵+\tilde{e}₁aᵢ⁴+\tilde{e}₃aᵢ³+\tilde{c}₀aᵢ²+\tilde{c}₁aᵢ+\tilde{c}₂. During the i^{th} iteration, for i>3, the data input is \tilde{c}ᵢ₋₁ and the parallel data input is zero. After the next active edge of clock 520, register 510 contains the value:

\tilde{e}_{i a}ᵢⁱ⁺²+\tilde{e}₁aᵢⁱ⁺¹+\tilde{e}₂aᵢⁱ+\tilde{c}₀aᵢⁱ⁻¹+ . . . +\tilde{c}ᵢ₋₂aᵢ+\tilde{c}ᵢ₋₁.

### After k+r iterations, register 510 contains the syndrome \tilde{c}(aᵢ).

The value of aᵢ³ can be computed using syndrome computer 400 in much the same way as the coefficients hᵢ of FIG. 3 were computed by encoder 100 of FIG. 1. If the input to syndrome computer 400 is one during the first iteration and zero during the next three iterations, the circuit will compute the value of the polynomial x³ at x=aᵢ. After the fourth iteration, register 410 will contain the value aᵢ³ . Syndrome computer 500 may be modified to handle a header with s data symbols by replacing constant multiplication by aᵢ³ by constant multiplication by aᵢ³. In addition parallel data 580 will be non-zero for the first s iterations and zero after that.

Based on the aforementioned discussion of parallel encoder and syndrome computers, it is apparent that a circuit may be modified to process data in parallel by adding certain constant multiples of the parallel input to the inputs to banks of flip-flops in the circuit. Thus, the same principles that yielded the parallel circuits of FIG. 3 and FIG. 5 can be applied to other circuits with parallel inputs. In such cases, parallel inputs are accepted for s clock cycles, and the constants in question are computed by operating the original circuit for s+1 clock cycles with an input of one on the first cycle and an input of zero on the subsequent cycles. Thus, one or more embodiments of the present invention provide a general class of circuits satisfying a certain linearity property.

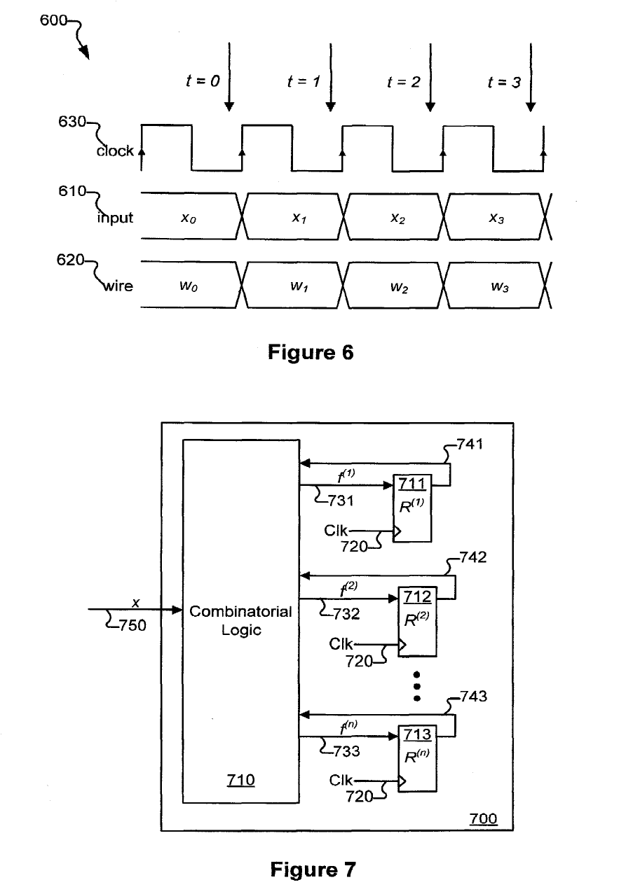

Such a general class of circuits includes standard circuit properties such as, but not limited to, input and output ports, wires, logical gates, and flip-flops for storing data. The flip-flops are synchronized by a clock so that new values are stored in the flip-flops on a determined active clock assertion and/or edge. Values of signals along wires (or groups of wires) in the circuit will be sampled at discrete moments in time. For example, the sampling may be done just prior to the active edge of the clock to allow adequate time for signals to propagate. Values in flip-flops will change sufficiently quickly after the active edge of the clock to assure proper circuit timing, and it is understood that the value on the input bus will also change on active edges of the clock, and thus for the purposes of the following discussion it is assumed that the values on the flip-flops change immediately after application of the active clock edge to the flip-flop. In the discussion, the value of s at a time t=i is denoted as sᵢ. Thus, each signal s in the circuit will be associated with the sequence s₀, s₁, s₂ . . . of its values at the various sampling times. This notation is depicted in FIG. 6 where a timing diagram 600 shows signal values for an input x 610, a group of wires w 620 that are sampled at discrete times t=0, t=1, t=2, t=3 as synchronized by a clock 630. While the following discussion does not take propagation delays into account, it is understood that one of ordinary skill in the art can apply such additional analysis based on the particulars of the circuitry that is to be designed.

As with the discussion of encoders and syndrome computers above, the generalized circuits are discussed with regard to a collection of M bits as an element of GF(2^{M}). In the approach, input bus x 610 is M bits wide and all flip-flops within the general circuit occur in groups of M flip-flops. Thus, suppose that there are n such registers R⁽¹⁾, R⁽²⁾, . . . , R⁽ⁿ⁾ and let the input to register R^{(j)} be f^{(j)}. The value f^{(j)} is a function of the input x and the values currently stored in the registers, as is illustrated in a linear circuit 700 of FIG. 7. Output ports are not shown in linear circuit 700, but will consist of groups of wires from the combinatorial logic and/or the registers. In particular, linear circuit 700 includes a combinatorial logic block 710 that is driven by an input x 750 and a number of feedback inputs 741, 742, 743 from respective registers 711, 712, 713. Registers 711, 712, 713 are synchronized by a clock 720. Combinatorial logic block 710 provides a number of outputs f^{(j)} 731, 732, 733 to the respective registers 711, 712, 713.

The formal power series x(D)=x₀+x₁D+x₂D²xₓD³+ . . . is associated with the sequence of values x₀, x₁, x₂, x₃ . . . where D is the usual delay operator. As is known in the art, the term “formal” power series refers to the fact that a value is not assigned to the variable D. Instead, arithmetic is performed on the power series in much the same way that polynomials are manipulated. Such arithmetic operations are limited to finite sums. For example, if

$$f ( D ) = {f}_{0} + {f}_{1} D + {f}_{2} {D}^{2} + {f}_{3} {D}^{3} + ⋯ , \\ g ( D ) = {g}_{0} + {g}_{1} D + {g}_{2} {D}^{2} + {g}_{3} {D}^{3} + ⋯ , and$$

$$h ( D ) = f ( D ) \cdot g ( D ) = {h}_{0} + {h}_{1} D + {h}_{2} {D}^{2} + {h}_{3} {D}^{3} + ⋯ , \\ then$$

$${h}_{0} = {f}_{0} \cdot {g}_{0 ,}$$

$${h}_{1} = {f}_{0} \cdot {g}_{1} + {f}_{1} \cdot {g}_{0} , \\ {h}_{2} = {f}_{0} \cdot {g}_{2} + {f}_{1} \cdot {g}_{1} + {f}_{2} \cdot {g}_{0} , \\ …$$

$${h}_{i} = {\sum }_{j = 0}^{i} {f}_{j} \cdot {g}_{i - j} .$$

There are similar formulas for computing the inverse of a power series. D. Knuth, “The Art of Computer Programming”, Second Edition. Addison-Wesley. Reading, Mass. 1981 provides additional information on arithmetic operations on power series. The aforementioned reference is incorporated herein by reference in its entirety. In the following discussion the operations of addition, subtraction, multiplication, and division performed on the coefficients are the usual arithmetic operations on GF(2^{M}). For each of the register inputs f^{(j)}, there is again a sequence of values f₀^{(j)}, f₁^{(j)}, f₂^{(j)}, f₃^{(j)}, . . . , and a formal power series f^{(j)}(D)=f₀^{(j)}+f₁^{(j)}D+f₂^{(j)}D²+f₃^{(j)}D³+ . . . . In this discussion, a circuit is considered is linear in the sense that the inputs to the register R^{(j)} are given by a transfer function t^{(j)} (D). Specifically, the transfer function is a formal power series t^{(j)}(D)=t₀^{(j)}+t₁⁽ⁱ⁾D+t₂^{(j)}D²+t₃^{(j)}D³+ . . . , such that f^{(j)}(D)=t^{(j)}(D)·x(D). The fact that there are no terms of negative degree in t^{(j)}(D) implies that the registers 711, 712, 713 are cleared before operation of the circuit.

Based on the foregoing, the register values can be thought of as an internal state and the input values as an external stimulus. The next state is completely determined by the current state and the input. At time t=i, the input value is xᵢ and the value in register R^{(j)} is fᵢ₋₁^{(j)}. (In particular, at the t=0, the value in register R^{(j)} is 0=f₋₁^{(j)}.) At that point the input to the register is fᵢ^{(j)} which is clocked into the register on the next active edge. As a simple example, suppose that x(D)=1, that is, suppose that the input at time t=0 is 1 and all subsequent inputs are 0. Then f^{(j)}(D)=t^{(j)}(D)·x(D)=t^{(j)}(D). Thus, with these inputs, register R^{(j)} contains tᵢ₋₁^{(j)} at time t=i and tᵢ^{(j)} is clocked into the register on the next active clock edge.

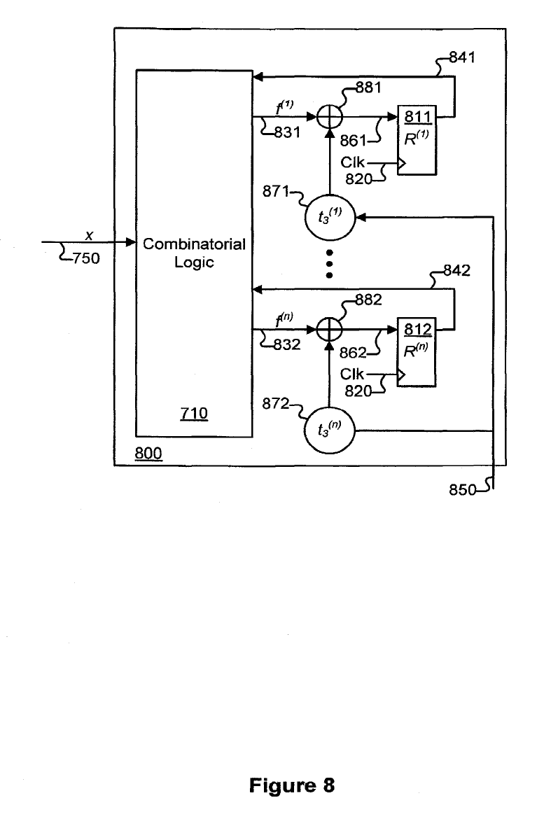

As with the encoder of FIG. 3 and the syndrome computer of FIG. 5, two parallel sequences of M-bit symbols d₀, d₁, d₂, . . . and e₀, e₁, e₂, . . . may be introduced to a circuit 800 of FIG. 8 that is essentially the circuit of FIG. 7 modified to accept parallel inputs rather than a single serial input. Using linear circuit 800, data set sequence d₀, d₁, d₂, . . . is introduced one M-bit symbol per clock cycle to input x 750, and data set sequence e₀, e₁, e₂, . . . is introduced one symbol per clock cycle to data input 850. After sufficient iterations have been completed so that all of the data from one or the other of inputs 750, 850 have been clocked in, the value placed on the satisfied input is set to zero. Thus, for example, where the e data set includes only three data elements and the d data set includes many more than three data elements, the value applied to input 850 is zero after the third iteration. After k iterations (i.e., the number of iterations to input all of the data input), the values in the registers will match the register values in linear circuit 700 after k+3 iterations. In the end, linear circuit 800 provides the same processed output as that of linear circuit 700, but in 3 fewer clock cycles. The operation of linear circuit 800 is discussed below in comparison to that of the previously described linear circuit 700.

It should be noted that serial input x 750 may accept a serial input comprising e₀, e₁, e₂, d₀, d₁, d₂, . . . introduced serially to the circuit. Where such is done, the sequence of inputs 750 to the linear circuit 700 is given by the following power series:

x(D)=e₀+e₁D+e₂D²+d₀D³+d₁D⁴+d₂D⁵+d₃D⁶⁺ . . . .

After k+3 iterations, where k is greater than or equal to three and equals the number of data symbols d₁, certain values will be stored in the registers of linear circuit 700. These values can be sampled at once, shifted out, or otherwise processed before producing the final result of a mathematical computation.

Linear circuit 700 may be modified to allow for parallel processing by adding one or more additional input ports such as that set forth in linear circuit 800 of FIG. 8. In particular, linear circuit 800 includes combinatorial logic block 710 that is driven by an input x 750 and a number of feedback inputs 841, 842 from respective registers 811, 812. Registers 811, 812 are synchronized by a clock 820. Combinatorial logic block 710 provides a number of outputs f^{(j)} 831, 832. In addition, linear circuit 800 includes a second input 850. Input 850 is multiplied by a multiplier 871 with the output of multiplier 871 being summed with output f^{(j)} 831 from combinatorial logic block 710 by an adder 881. An output 861 from adder 881 is provided to register 811. Input 850 is also multiplied by a multiplier 872 with the output of multiplier 872 being summed with output f⁽ⁿ⁾ 832 from combinatorial logic block 710 by an adder 882. An output 862 from adder 882 is provided to register 812. In linear circuit 800, t₂^{(j)} is the coefficient of D³ in the power series t^{(j)}(D) where the data set to be applied to input 850 includes three serially introduced elements. Multipliers 871, 872 containing the aforementioned number are constant multipliers. In linear circuit 800, the value of each f^{(j)} is determined by the input value 750 and the values in registers 811, 812 and is independent of input 850. Thus, if input 750 in circuit 800 is the same as input 750 in circuit 700 and the values in registers 811, 812 in circuit 800 are the same as the corresponding register values in circuit 700, the values f^{(j)} in circuit 800 will also be the same as the corresponding values f^{(j)} in circuit 700. The value of f^{(j)} is computed in the original circuit 700 using transfer functions.

For example, if the registers in the previously discussed linear circuit 700 have been cleared and input 750 is d₀, then the value f₀^{(j)}=t₀^{(j)}d₀ will be clocked into register R^{(j)} at time t=0. Likewise, if the registers in the circuit 800 have been cleared, the input 750 is d₀, and input 850 is e₀, then the values of t₀^{(j)}d₀+t₃^{(j)}e₀ are clocked into the registers at time t=0. At time t=1, the values t₀^{(j)}d_{; +t}₃^{(j)}e₀ are stored in the registers in circuit 800 and the value on input 750 is d₁ and the value on the input 850 is e₁. The values f₁^{(j)} can be determined by constructing a scenario where the values t₀^{(j)}d₀+t₃^{(j)}e₀ are stored in the registers in circuit 700 and the input 750 to that circuit is d₁. Suppose that the sequence of inputs 750 to circuit 700 is given by the power series x(D)=e₀+d₀D³+d₁D⁴+ . . . . Then

$$\begin{matrix}{f}^{( j )} ( D ) = {t}^{( j )} ( D ) \cdot x ( D ) \\ = ( {t}_{0}^{( j )} + {t}_{1}^{( j )} D + {t}_{2}^{( j )} {D}^{2} + {t}_{3}^{( j )} {D}^{3} + {t}_{4}^{( j )} {D}^{4} + ⋯ ) \cdot \\ ( {e}_{0} + {d}_{0} {D}^{3} + {d}_{1} {D}^{4} + ⋯ ) \\ = {t}_{0}^{( j )} {d}_{0} + {t}_{1}^{( j )} {e}_{0} D + {t}_{2}^{( j )} {e}_{0} {D}^{2} + ( {t}_{0}^{( j )} {d}_{0} + {t}_{3}^{( j )} {e}_{0} ) {D}^{3} + \\ ( {t}_{0}^{( j )} {d}_{1} + {t}_{1}^{( j )} {d}_{0} + {t}_{4}^{( j )} {e}_{0} ) {D}^{4} + ⋯\end{matrix}$$

Thus, at time t=4, the input 750 to circuit 700 is d₁, the value stored in register R^{(j)} is t₀^{(j)}d₀+t₃^{(j)}e₀ and the value f₄^{(j)} that is clocked into register R^{(j)} is t₀^{(j)}d₁+t₁^{(j)}d₀+t₄^{(j)}e₀. Returning to circuit 800, at time t=1, the value t₀^{(j)}d₀+t₃^{(j)}e₀ is stored in register R^{(j)} and the value on input 750 is d₁. Thus, the value of f^{(j)} is again t₀^{(j)}d₁+t₁^{(j)}d₀+t₄^{(j)}e₀. Taking into account the input 850 with value e₁, the value clocked into register R^{(j)} is t₀^{(j)}d₁+t₁^{(j)}d₀+t₃^{(j)}e₁+t₄^{(j)}e₀.

Similarly, we will construct a scenario in which the value t₀^{(j)}d₁+t₁^{(j)}d₀+t₃^{(j)}e₁+t₄^{(j)}e₀ is stored in register R^{(j)} of linear circuit 700 and the input value is d₂. If x(D)=e₀+e₁D+d₀D³+d₁D⁴+d₂D⁵+ . . . , then

$$\begin{matrix}{f}^{( j )} ( D ) = {t}^{( j )} ( D ) \cdot x ( D ) \\ = ( {t}_{0}^{( j )} + {t}_{1}^{( j )} D + {t}_{2}^{( j )} {D}^{2} + {t}_{3}^{( j )} {D}^{3} + {t}_{4}^{( j )} {D}^{4} + {t}_{5}^{( j )} {D}^{5} + ⋯ ) \cdot \\ ( {e}_{0} + {e}_{1} D + {d}_{0} {D}^{3} + {d}_{1} {D}^{4} + ⋯ ) \\ = {t}_{0}^{( j )} {e}_{0} + ( {t}_{0}^{( j )} {e}_{1} + {t}_{1}^{( j )} {e}_{0} ) D + ( {t}_{1}^{( j )} {e}_{1} + {t}_{2}^{( j )} {e}_{0} ) {D}^{2} + \\ ( {t}_{0}^{( j )} {d}_{0} + {t}_{2}^{( j )} {e}_{1} + {t}_{3}^{( j )} {e}_{0} ) {D}^{3} + \\ ( {t}_{0}^{( j )} {d}_{1} + {t}_{1}^{( j )} {d}_{0} + {t}_{3}^{( j )} {e}_{1} + {t}_{4}^{( j )} {e}_{0} ) {D}^{4} + \\ ( {t}_{0}^{( j )} {d}_{2} + {t}_{1}^{( j )} {d}_{1} + {t}_{2}^{( j )} {d}_{0} + {t}_{4}^{( j )} {e}_{1} + {t}_{5}^{( j )} {e}_{0} ) {D}^{5} + ⋯\end{matrix}$$

Therefore, at time t=5 the value stored in R^{(j) is t}₀^{(j)}d₁+t₁^{(j)}d₎+t₃^{(j)}e₁+t₄^{(j)}e₀, input value 750 is d₁, and the value of f^{(j)} is t₀^{(j)}d₂+t₁^{(j)}d₁+t₂^{(j)}d₀+t₄^{(j)}e₁+t₅^{(j)}e₀ In linear circuit 800, input value 850 is e₂ and the input to R^{(j)} at time t=2 is t₀^{(j)}d₂+t₁^{(j)}d₁+t₂^{(j)}d₀+t₃^{(j)}e₂+t₄^{(j)}e₁+t₅^{(j)}e₀.

Finally, if x(D)=e₀+e₁D+e₂D²+d₀D³+d₁D⁴+d₂D⁵+d₃D⁶+ . . . , then the coefficient of D⁵ in t^{(j)}(D)·x(D) is t₀^{(j)}d₂+t₁^{(j)}d₁+t₂^{(j)}d₀+t₃^{(j)}e₂+t₄^{(j)}e₁+t₅^{(j)}e₀. This is the value stored in the registers, R^{(j)}, in linear circuit 700 at time t=6 and in linear circuit 800 after only three clock cycles or time t=3. As the e data set is zero after e₂, the values in the registers of linear circuit 800 at any time t=i will match those in linear circuit 700 at time t=i+3. In particular, the values in the registers of both linear circuit 700 and linear circuit 800 will match after the last data symbol dₖ₋₁ has been processed by each of circuits 700, 800. Thus, by using linear circuit 800 that is capable of processing the same amount of input elements in three fewer clock cycles, substantial time savings may be achieved at the cost of only a moderate amount of additional circuitry.

Using linear circuit 800, data set sequence d₀, d₁, d₂ is introduced one symbol per clock cycle to input x 750, and data set sequence e₀, e₁, e₂ is introduced to data input 850. After sufficient iterations have been completed so that all of the data from one or the other of inputs 750, 850 have been clocked in, the value placed on the satisfied input is set to zero. Thus, for example, where the e data set includes only three data elements and the d data set includes many more than three data elements, the value applied to input 850 is zero after the third iteration. After k iterations (i.e., the number of iterations to input all of the data d), the values in the registers in linear circuit 800 will match the corresponding register values in linear circuit 700 after k+3 iterations. The register values can then be processed as before to produce the desired result.

Constant multipliers 871, 872 of linear circuit 800 may be found by operating circuit 700 for four iterations, i.e. for a number of iterations that is one greater than the number of data elements to be introduced via input 850. The value t₃^{(j)} is the coefficient of D³ in the transfer function t^{(j)}(D). If x(D)=1, then the first input is one and all subsequent inputs are zero. Moreover, f^{(j)}(D)=t^{(j)}(D)·x(D)=t^{(j)}(D). Thus, so t₃^{(j)} is the value clocked into R^{(j)} on the active clock edge after time t=3. Again, in actual practice, this computation could be performed by operating (or simulating the operation of) linear circuit 700.

It should be noted that the circuits discussed in relation to FIG. 7 and FIG. 8 may be expanded to operate on any number of parallel input symbols (i.e. e) as long as the number s of parallel input symbols does not exceed the number of data symbols. Thus, in a more general case, the value used for the constant multiplier is tₛ^{(j)}, which again can be computed by running linear circuit 700 for s+1 iterations, where s equals the number of parallel input data symbols. The same method can be used to verify that the modified circuit performs as it should.

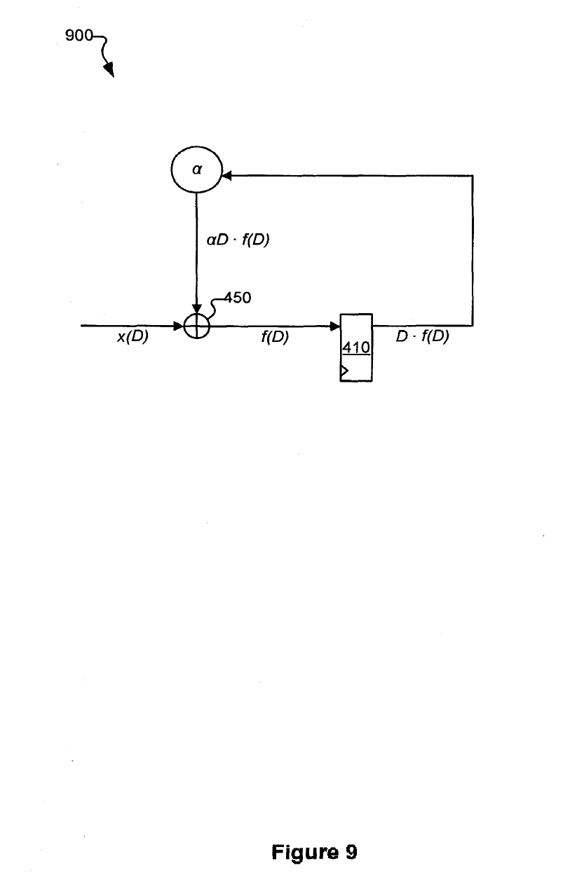

It should be noted that the syndrome computer of FIG. 4 can be described in terms of a power series transfer function computation similar to that performed in relation to FIG. 7 above, and that by using the power series, a parallel input may be added to the circuit similar to that described in relation to FIG. 8 above. In such a case, the output from register 410 of FIG. 4 is the input of the same register delayed by one clock cycle. In terms of formal power series, this corresponds to multiplication by D. Likewise, the power series corresponding to the output of adder 450 is the sum of the power series corresponding to the two inputs. The syndrome computer of FIG. 4 is provided as a syndrome computer 900 of FIG. 9 with power series noted at the associated areas on the diagram. Therefore:

$$f ( D ) = x ( D ) + a D f ( D ) , thus$$

$$f ( D ) + a D f ( D ) = x ( D ) , and$$

$$f ( D ) = ( \frac{1}{1 + a D} ) \cdot x ( D ) .$$

Therefore, the transfer function is:

$$t ( D ) = ( \frac{1}{1 + aD} ) = 1 + aD + {a}^{2} {D}^{2} + {a}^{3} {D}^{3} + ⋯$$

Since t₃=a³, the general construction results in the same circuit as was constructed in relation to FIG. 5 above. Also note that the coefficients of the product t(D)·x(D) are the partial results in the Homer evaluation:

$$\begin{matrix}t ( D ) \cdot x ( D ) = ( 1 + aD + {a}^{2} {D}^{2} + {a}^{3} {D}^{3} + ⋯ ) * ( {x}_{0} + {x}_{1} D + {x}_{2} {D}^{2} + {x}_{3} {D}^{3} + ⋯ ) \\ = {x}_{0} + ( {x}_{0} a + {x}_{1} ) D + ( {x}_{0} {a}^{2} + {x}_{1} a + {x}_{2} ) {D}^{2} + \\ ( {x}_{0} {a}^{3} + {x}_{1} {a}^{2} + {x}_{2} a + {x}_{3} ) {D}^{3} + ⋯\end{matrix}$$

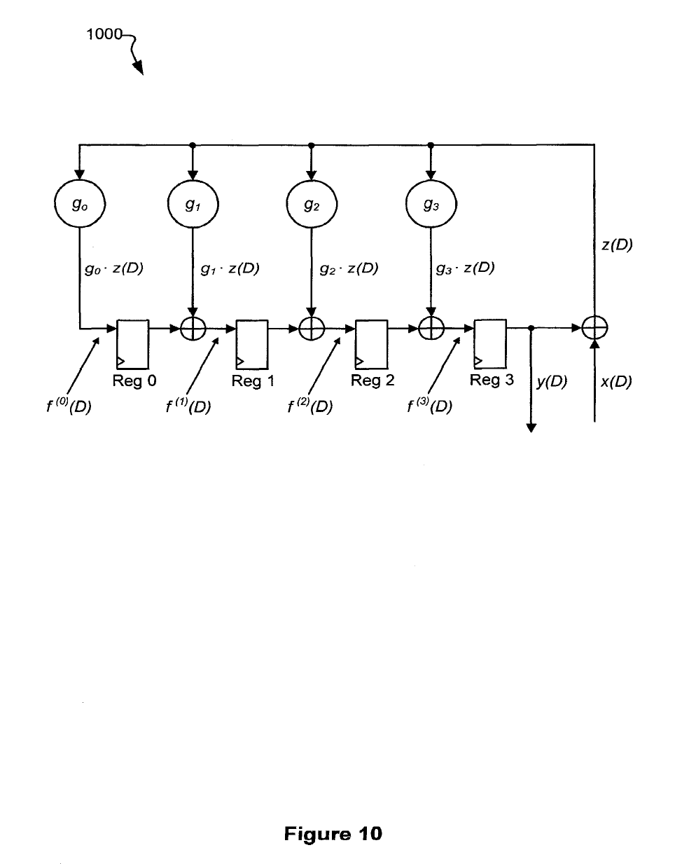

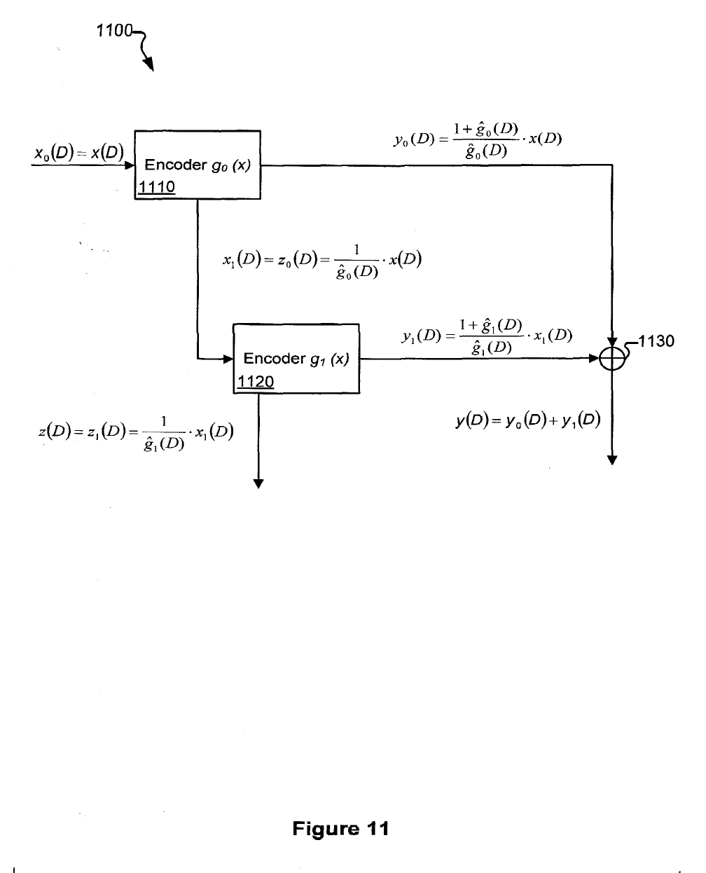

Similarly, it should be noted that the encoder circuit of FIG. 1 can be described in terms of power series transfer functions similar to that performed in relation to FIG. 7 above, and that by using the various power series a parallel input may be added to the circuit similar to that described in relation to FIG. 8 above. The power series associated with the encoder are shown in relation to encoder 1000 of FIG. 10. In particular:

f⁽⁰⁾(D)=g₀·z(D)

f⁽¹⁾(D)=(g₀D+g₁)·z(D)

f⁽²⁾(D)=(g₀D²+g₁D+g₂)·z(D)

f⁽³⁾(D)=(g₀D³+g₁D²+g₂D+g₃)·z(D)

### If ĝ(x) is g(x) with the coefficients reversed (i.e., ĝ(x)=1+g₃x+g₂x²+g₁x³+g₀x⁴), then y(D)=(1+ĝ(D))·z(D). Therefore:

$$z ( D ) = x ( D ) + y ( D )$$

$$z ( D ) = x ( D ) + ( 1 + \hat{g} ( D ) ) \cdot z ( D )$$

$$\hat{g} ( D ) \cdot z ( D ) = x ( D )$$

$$z ( D ) = \frac{1}{\hat{g} ( D )} x ( D )$$

It thus follows that the inputs to each of the four registers is given by a transfer function, and from the figure we see that:

$${t}^{( 0 )} ( D ) = \frac{{g}_{0}}{\hat{g} ( D )}$$

$${t}^{( 1 )} ( D ) = \frac{{g}_{0} D + {g}_{1}}{\hat{g} ( D )}$$

$${t}^{( 2 )} ( D ) = \frac{{g}_{0} {D}^{2} + {g}_{1} D + {g}_{2}}{\hat{g} ( D )}$$

$${t}^{( 3 )} ( D ) = \frac{{g}_{0} {D}^{3} + {g}_{1} {D}^{2} + {g}_{2} D + {g}_{3}}{\hat{g} ( D )}$$

### Moreover, since

$$\frac{1}{\hat{g} ( D )} = 1 + {g}_{3} D + ( {g}_{3}^{2} + {g}_{2} ) {D}^{2} + ( {g}_{3}^{3} + {g}_{1} ) {D}^{3} + ( {g}_{3}^{4} + {g}_{2} {g}_{3}^{2} + {g}_{2}^{2} + {g}_{0} ) {D}^{4} + ⋯$$

each t^{(j)}(D) has a power series expansion. Proceeding through the calculation, it can be shown that the coefficients of D³ in the transfer functions give the coefficients of X⁷ (mod g(x)).

In one particular embodiment of the present invention, an encoder with a programmable parity level is a circuit of the type discussed above in relation to FIG. 7 and Fie. 8. Note first that the circuit in FIG. 10 has an input x(D) and an output y(D), where

$$y ( D ) = \frac{1 + \hat{g} ( D )}{\hat{g} ( D )} \cdot x ( D )$$

for a given generator polynomial g(x). It is a simple matter to construct the encoder in FIG. 1 from the circuit in FIG. 10: a multiplexer 350 is added, whose inputs 154, 152 are y(D) as in FIG. 10 and the data input to the encoder. The output 160 of the multiplexer then is connected to the input x(D) in FIG. 10. This approach can be used to construct a systematic encoder for the code with generator polynomial g(x) from any circuit having an input x(D) and an output

$$y ( D ) = \frac{1 + \hat{g} ( D )}{\hat{g} ( D )} \cdot x ( D )$$

for the given generator polynomial g(x). To avoid unstable feedback loops, one must add the requirement that every path from the input x(D) to the output y(D) passes through at least one flip-flop. The idea behind a programmable encoder is that there will be outputs

$$y ( D ) = \frac{1 + \hat{g} ( D )}{\hat{g} ( D )} \cdot x ( D )$$

for more than one generator polynomial g(x).

The programmable parity level encoder can be constructed from linear circuits of the type in FIG. 10, that is from linear circuits with an input x(D) and an output y(D), where

$$y ( D ) = \frac{1 + \hat{g} ( D )}{\hat{g} ( D )} \cdot x ( D ) .$$

### For the purposes of this discussion, a second output z(D) is added to the circuit, where

$$z ( D ) = \frac{1}{\hat{g} ( D )} \cdot x ( D ) .$$

First suppose that the generator polynomial g(x) factors into a product of 2 polynomials: g(x)=g, (x)·g₁(x). A circuit, having an input x(D) and an output y(D) as above, can be constructed from 2 sub-circuits, one for each of the factors of g(x). We will briefly describe the construction below. A corresponding encoder 1100 is depicted in FIG. 11 including the various power series associated with the inputs and outputs of the encoder sub-circuits 1110, 1120. The circuit 1110 has an input x₀(D) and outputs

$${y}_{0} ( D ) = \frac{1 + {\hat{g}}_{0} ( D )}{{\hat{g}}_{0} ( D )} \cdot {x}_{0} ( D ) and {z}_{0} ( D ) = \frac{1}{{\hat{g}}_{0} ( D )} \cdot {x}_{0} ( D ) .$$

### The circuit 1120 has an input x₁(D) and outputs

$${y}_{1} ( D ) = \frac{1 + {\hat{g}}_{1} ( D )}{{\hat{g}}_{1} ( D )} \cdot {x}_{1} ( D ) and {z}_{1} ( D ) = \frac{1}{{\hat{g}}_{1} ( D )} \cdot {x}_{1} ( D )$$

### The output z₀(D) of circuit 1110 is used as the input x₁(D) of circuit 1120. The outputs y₀(D) and y₁(D) of encoder sub-circuits 1110, 1120 are aggregated using an adder 1130. First note that

$$z ( D ) = {z}_{1} ( D ) = \frac{1}{{\hat{g}}_{1} ( D )} \cdot {x}_{1} ( D ) = \frac{1}{{\hat{g}}_{1} ( D )} \cdot \frac{1}{{\hat{g}}_{0} ( D )} \cdot {x}_{0} ( D ) = \frac{1}{\hat{g} ( D )} \cdot x ( D ) .$$

### Next note that

$$\begin{matrix}y ( D ) = {y}_{0} ( D ) + {y}_{1} ( D ) \\ = \frac{1 + {\hat{g}}_{0} ( D )}{{\hat{g}}_{0} ( D )} \cdot {x}_{0} ( D ) + \frac{1 + {\hat{g}}_{1} ( D )}{{\hat{g}}_{1} ( D )} \cdot {x}_{1} ( D ) \\ = \frac{1 + {\hat{g}}_{0} ( D )}{{\hat{g}}_{0} ( D )} \cdot \frac{{\hat{g}}_{1} ( D )}{{\hat{g}}_{1} ( D )} \cdot {x}_{0} ( D ) + \frac{1 + {\hat{g}}_{1} ( D )}{{\hat{g}}_{1} ( D )} \cdot \frac{1}{{\hat{g}}_{0} ( D )} {x}_{0} ( D ) \\ = \frac{1 + {\hat{g}}_{0} ( D ) {\hat{g}}_{1} ( D )}{{\hat{g}}_{0} ( D ) {\hat{g}}_{1} ( D )} \cdot {x}_{0} ( D ) \\ = \frac{1 + \hat{g} ( D )}{\hat{g} ( D )} \cdot x ( D )\end{matrix}$$

Thus, the circuit 1100 in FIG. 11 can be used to construct an encoder for the generator polynomial g(x) in the same way that the encoder in FIG. 1 was constructed from the circuit in FIG. 10. Moreover, if the encoder 1120 is “disabled” so that the output y₁(D) is 0, then the output y(D) is simply y₀(D) and the encoder acts as an encoder for the generator polynomial g₀(D). By controlling the disabling of encoder 1120, the resulting encoder can act as an encoder for either the generator polynomial g₀(x) or the generator polynomial g₀(x)·g₁(x)=g(x). In the first case, the encoder will compute deg(g₀) parity symbols and in the second case, the encoder will compute deg(g) parity symbols.

Additional information about such circuit construction is available in Jonathan Ashley et al., “A Combined Encoder/Syndrome Computer with Programmable Parity Level”, Agere Internal White Paper, 2005. The aforementioned document is incorporated herein by reference in its entirety for all purposes.

Further, where the circuit of FIG. 11 is modified along the lines of that discussed in relation to FIG. 7 and FIG. 8 above, the modified circuit will support parallel encoding for the generator polynomial g(x). The modified circuit will also support parallel encoding for the generator polynomial g₀(x) when the second sub-circuit is disabled. The inputs to the flip-flop in the first sub-circuit are not affected by any of the flip-flops in the second sub-circuit. Therefore, when we operate the circuit for s+1 clock cycles to determine the values used for the constant multipliers, the values computed for the first sub-circuit will be the same, whether or not the second sub-circuit is disabled.

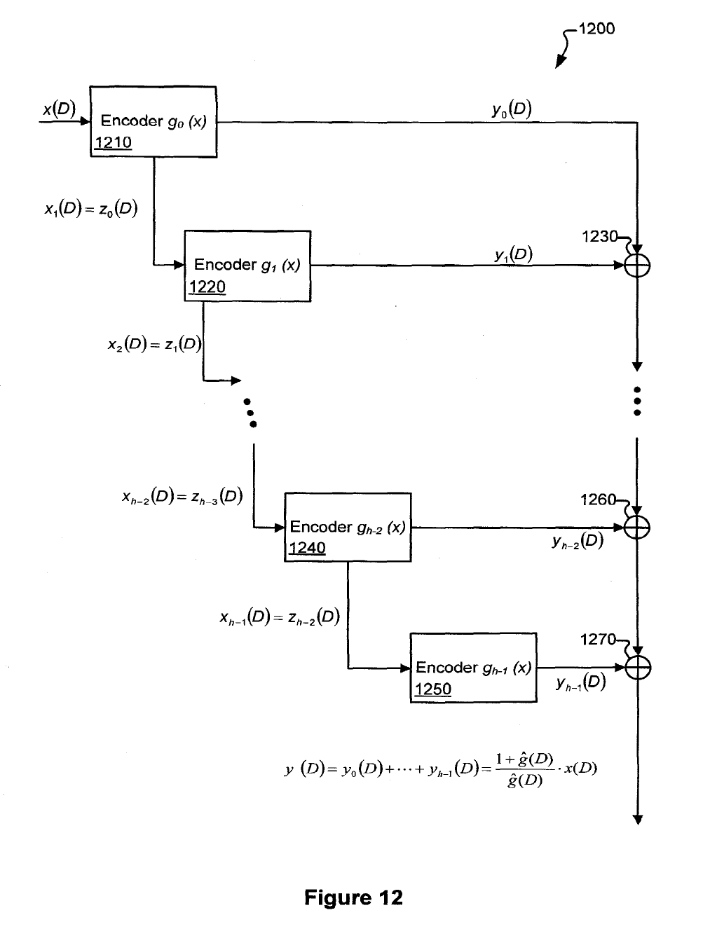

Encoder 1100 of FIG. 11 generalizes easily to an encoder with h sub-circuits as is depicted as encoder 1200 of FIG. 12. Here the generator polynomial g(x) has h factors: g(x)=g₀(x)·g₁(x) . . . gₕ₋₂(x)·gₕ₋₁(x) and there are h sub-circuits of the type in FIG. 10, one for each of the factors of g(x). The sub-circuits of the aforementioned discussion may be expanded and each have an input x₁(D) and outputs y₁(D) and z₁(D), where

$${y}_{i} ( D ) = \frac{1 + {\hat{g}}_{i} ( D )}{{\hat{g}}_{i} ( D )} \cdot {x}_{i} ( D )$$

$${z}_{i} ( D ) = \frac{1}{{\hat{g}}_{i} ( D )} \cdot {x}_{i} ( D )$$

Such an expanded encoder circuit 1200 is depicted in FIG. 12 with the associated power series shown thereon. The input x(D) to a sub-circuit 1210 is the input x₀(D), the input to a sub-circuit 1220 is the input x₁(D)=z₀(D), the input to a sub-circuit 1240 is the input xₕ₋₂(D)=zₕ₋₃(D), and the input to a sub-circuit 1250 is the input xₕ₋₁(D)=zₕ₋₂(D). In general, the input to the i^{th} sub-circuit is xᵢ₋₁(D)=zᵢ₋₂(D). The outputs of each of sub-circuits 1210, 1220, 1230, 1240 are aggregated using adders 1230, 1260, 1270. Encoder 1200 supports the h generator polynomials g⁽ⁱ⁾(x)=g₀(x)·g₁(x) . . . gᵢ₋₁(x) as i ranges from 1 to h. To work with the generator polynomial g⁽ⁱ⁾(x), the first i sub-circuits are left enabled and the remaining h−i sub-circuits are disabled. The construction to allow parallel processing works since the inputs to the flip-flops in the first i sub-circuits are unaffected by the values in the flip-flops in the remaining h−i sub-circuits.

In conclusion, the present invention provides novel systems, devices, methods and arrangements for processing data sets in parallel. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A parallel linear processing device, the processing device comprising:
a first multiplier, wherein the first multiplier is operable to multiply a feedback signal by a first value and to provide a first multiplier output;
a second multiplier, wherein the second multiplier is operable to multiply a data input by a second value and to provide a second multiplier output;
an adder, wherein the adder is operable to sum at least the first multiplier output and the second multiplier output and to provide an adder output; and
a register, wherein the register is operable to register the adder output as a register output, and wherein the feedback signal is derived from the register output.

2. The processing device of claim 1, wherein the adder is a first adder, wherein the data input is a first data input, wherein the processing device is a parallel encoding device, and wherein the parallel encoding device further includes:
a multiplexer, wherein the multiplexer is operable to select between a second data input and the register output to drive an encoder output; and
a second adder, wherein the second adder is operable to sum the register output with the encoder output and to provide the feedback signal.

3. The processing device of claim 2, wherein the first value is a coefficient of a term of a polynomial of a first degree, wherein the second value is a coefficient of a term of the polynomial of a second degree, and wherein the first degree is a greater degree than the second degree.

4. The processing device of claim 2, wherein the second data input is a series of base data, wherein the first data input is a series of data describing the base data, and wherein the encoder output includes an encoded version of an aggregate of the base data and error correction data calculated based on the combination of the base data and the data describing the base data.

5. The processing device of claim 4, wherein the error correction data is parity data.

6. The processing device of claim 4, wherein the base data is user data stored to a magnetic storage medium, and wherein the data describing the base data is header data associated with the base data.

7. The processing device of claim 1, wherein the data input is a first data input, wherein the processing device is a parallel syndrome computing device, and wherein the parallel syndrome computing device further includes:
a second data input, wherein the second data input is summed with the first multiplier output and the second multiplier output by the adder.

8. The processing device of claim 7, wherein the first value is a coefficient of a term of a polynomial of a first degree, wherein the second value is a coefficient of a term of the polynomial of a second degree, and wherein the first degree is a greater degree than the second degree.

9. The processing device of claim 7, wherein the second data input is a series of base data, wherein the first data input is a series of data describing the base data, and wherein a syndrome output is a syndrome value upon completion of the syndrome process.

10. The processing device of claim 9, wherein the base data is user data stored to a magnetic storage medium, and wherein the data describing the base data is header data associated with the base data.

11. A method for processing in a syndrome computer, the method comprising:
providing a processing device, wherein the processing device includes:
a first multiplier, wherein the first multiplier is operable to multiply a register output by a first value and to provide a first multiplier output;
a second multiplier, wherein the second multiplier is operable to multiply a first data input by a second value and to provide a second multiplier output;
a first adder, wherein the first adder is operable to sum the first multiplier output, the second multiplier output and a second data input, and to provide an adder output; and
a register, wherein the register is operable to register the adder output as the register output;
initializing the register to a known state;
applying a first data element to the first data input, and applying a second data element to the second data input, wherein the first data element is a first coefficient of a polynomial and the second is a second coefficient of the polynomial; and
clocking the register, wherein upon clocking the register contains a polynomial value.

12. A method for encoding two data sets in parallel, the method comprising:
providing an encoder circuit, wherein the encoder circuit includes:
a multiplexer, wherein the multiplexer is operable to select between a first data input and a second register output to drive an encoder output;
a first adder, wherein the first adder is operable to sum the second register output with the encoder output and to provide a first adder output;
a first multiplier, wherein the first multiplier is operable to multiply the first adder output by a first value and to provide a first multiplier output;
a second multiplier, wherein the second multiplier is operable to multiply a second data input by a second value and to provide a second multiplier output;
a second adder, wherein the second adder is operable to sum the first multiplier output with the second multiplier output and to provide a second adder output;
a first register, wherein the first register is operable to register the second adder output as the a first register output;
a third multiplier, wherein the third multiplier is operable to multiply the first adder output by a third value and to provide a third multiplier output;
a fourth multiplier, wherein the fourth multiplier is operable to multiply the second data input by a fourth value and to provide a fourth multiplier output;
a third adder, wherein the third adder is operable to sum the third multiplier output, the fourth multiplier output and the first register output together, and to provide a third adder output;
a second register, wherein the second register is operable to register the third adder output as the a second register output;
initializing the first register and the second register to a known state;
applying a first data element to the first data input, and applying a second data element to the second data input; and
clocking the second register, wherein the second register contains a first coefficient of a first degree of a polynomial and a second coefficient of a second degree of the polynomial, wherein the first data element is a first coefficient of a first degree of the polynomial and the second data element is a second coefficient of a second degree of the polynomial.

13. The method of claim 12, wherein the method further includes:
subsequently, applying a third data element to the first data input and a fourth data element to the second data input; and
subsequently, clocking the first register and the second register, wherein the first register and the second register contain coefficients of a polynomial of a second degree, and wherein the second degree is greater than the first degree.

14. The method of claim 13, wherein the first data element is an element of a base data set, and wherein the second data element is an element of a header data set associated with the first data set.

15. A generalized parallel linear processing device, the processing device comprising:
a first register and a second register, wherein each of the first register and the second register are synchronized to a clock;
a combinatorial logic block, wherein the combinatorial logic block receives a first input, an output from the first register and an output from the second register, and wherein the next state of the combinatorial logic is calculated as a linear function of the current state and the first input;
a first input modifier, wherein the first input modifier is operable to modify a second input and to provide a first modified output;
a second input modifier, wherein the second input modifier is operable to modify the second input and to provide a second modified output;
a first adder, wherein the first adder is operable to sum the first modified output with a first combinatorial logic output and to provide a first adder output;
a second adder, wherein the second adder is operable to sum the second modified output with a second combinatorial logic output and to provide a second adder output; and
wherein the first adder output is registered in the first register upon assertion of the clock, and wherein the second adder output is registered in the second register upon assertion of the clock.

16. The processing device of claim 15, wherein the processing device is a linear system exhibiting a state update formula in accordance with the following equation: Sᵢ₊₁=M·Sᵢ+L·U₁, wherein S₀ equals zero, wherein M is a linear map from a state space to itself, and wherein L is a linear map from the input to the state space.
